(19) United States
(12) Patent Application Publication
(10) Pub. No.: US 2019/0030733 A1
(43) Pub. Date: Jan. 31, 2019

(54) TORSIONAL ROTATIONAL JOINT MECHANISM, ROBOT ARM MECHANISM AND CANTILEVERED ROTATION MECHANISM

(71) Applicant: LIFE ROBOTICS INC., Tokyo (JP)

(72) Inventor: Woo-Keun YOON, Tokyo (JP)

(21) Appl. No.: 16/146,753

(22) Filed: Sep. 28, 2018

Related U.S. Application Data
(63) Continuation of application No. PCT/JP2017/012210, filed on Mar. 26, 2017.

(30) Foreign Application Priority Data
Mar. 29, 2016 (JP) 2016-066895

(51) Int. Cl. B25J 17/02; B25J 18/02

(52) U.S. Cl. CPC B25J 17/0258; F16H 19/0636; B25J 18/025

(57) ABSTRACT

Provided is a torsional rotational joint mechanism that realizes simplification of a structure, reduction in weight, and falling-off prevention. The torsional rotational joint mechanism that is mounted to a robot arm mechanism includes a fixed section in a cylindrical shape, a motor unit that is housed in the fixed section, and a rotating section that is fixed to an output shaft 65 of the motor unit. A flange section in an annular shape is jutted out on an outer circumferential surface of a tip of the fixed section to project outward, and one or two or more falling-off prevention sections are attached to a rear end surface of the rotating section in such a manner that the flange section on the fixed section is sandwiched between the one or two or more falling-off prevention sections and the rear end surface of the rotating section.

### CROSS-REFERENCE TO RELATED APPLICATIONS

This application is a continuation application of International Patent Application No. PCT/JP2017/012210 filed on Mar. 26, 2017, which is based upon and claims the benefit of priority from the prior Japanese Patent Application No. 2016-066895, filed Mar. 29, 2016 the entire contents of which are incorporated herein by reference.

### FIELD

Embodiments described herein relate generally to a torsional rotational joint mechanism, a robot arm mechanism and a cantilevered rotation mechanism.

### BACKGROUND

Conventionally, an articulated robot arm mechanism has been used in various fields such as an industrial robot. A linear extension and retraction mechanism that has been put to practical use by the inventors is an effective mechanism that does not require an elbow joint of a vertical-articulated-type robot arm mechanism including the linear extension and retraction mechanism, and can realize disposition of the robot in the vicinity of a worker.

An arm section constituting the linear extension and retraction mechanism is constituted by overlapping a piece string formed by bendably connecting flat-plate-shaped pieces and a piece string formed by bendably connecting groove-shaped pieces with each other. An overlapped state of the arm section is kept by a rear end of the arm section being firmly held by a roller unit, and the arm section at this time includes a certain rigidity.

A wrist section is attached to a tip of the arm section. An end effector is fitted to the wrist section. The wrist section is typically equipped with three rotational joints combined into orthogonal three axes to make a posture of the end effector freely changeable, and it is desired to realize simplification of the structure, and reduction in weight as well as prevention of falling-off of the wrist section.

### CITATION LIST

### Patent Literature

[Patent Literature 1] Japanese Patent No. 5435679

### SUMMARY OF INVENTION

### Technical Problem

An object of the present invention is to provide a torsional rotational joint mechanism, a robot arm mechanism and a cantilevered rotation mechanism that realize simplification of a structure, reduction in weight and prevention of falling-off.

### Solution to Problem

A torsional rotational joint mechanism according to the present embodiment includes a cylindrical fixed section, a motor unit that is housed in the fixed section, and a rotating section that is fixed to an output shaft of the motor unit. A flange section in an annular shape is jutted out at one of the fixed section and the rotating section to project outward. One or two or more falling-off prevention sections is or are attached to an end surface of the other one of the fixed section and the rotating section in such a manner that the flange section is sandwiched between the one or two or more falling-off prevention sections and the end surface of the other one of the fixed section and the rotating section.

### BRIEF DESCRIPTION OF THE VIEWS OF THE DRAWING

FIG. 1 illustrates an external view of a robot arm mechanism equipped with a torsional rotational joint mechanism according to a present embodiment;

FIG. 2 is a view illustrating a structure of the robot arm mechanism in FIG. 1 by graphic symbol expression;

FIG. 3 is a side view illustrating an internal structure of the robot arm mechanism in FIG. 1;

FIG. 4 is a diagram illustrating the structure of the robot arm mechanism in FIG. 1 by graphic symbol expression;

FIG. 5 is a perspective view illustrating a structure of a joining section of a wrist section and an arm section in FIG. 3;

FIG. 6 is a perspective view illustrating a structure of a torsional rotational joint mechanism according to the present embodiment;

FIG. 7 is a side view of the torsional rotational joint mechanism in FIG. 6;

FIG. 8 is a sectional view taken along line A-A in the torsional rotational joint mechanism in FIG. 7;

FIG. 9 is a plan view illustrating a falling-off prevention plate of the torsional rotational joint mechanism in FIG. 6;

FIGS. 10A, 10B and 10C are views illustrating other examples of the falling-off prevention plate in FIG. 9; and

FIG. 11 is a vertical sectional view illustrating another structure of the torsional rotational joint mechanism according to the present embodiment.

### DETAILED DESCRIPTION

Hereinafter, a torsional rotational joint mechanism according to a present embodiment will be described with reference to the accompanying drawings. Note that the torsional rotational joint mechanism according to the present embodiment can be used as a single mechanism (joint). In the following explanation, a robot arm mechanism in which one joint among a plurality of joints is constituted of a torsional rotational joint mechanism according to the present embodiment will be described as an example. Here, a vertical-articulated-type robot arm mechanism including a linear extension and retraction mechanism will be described as the robot arm mechanism, but the robot arm mechanism may be another type of robot arm mechanism. In the following description, the same reference numerals denote components having substantially identical functions and structures, and the repeated description thereof is made only when necessary.

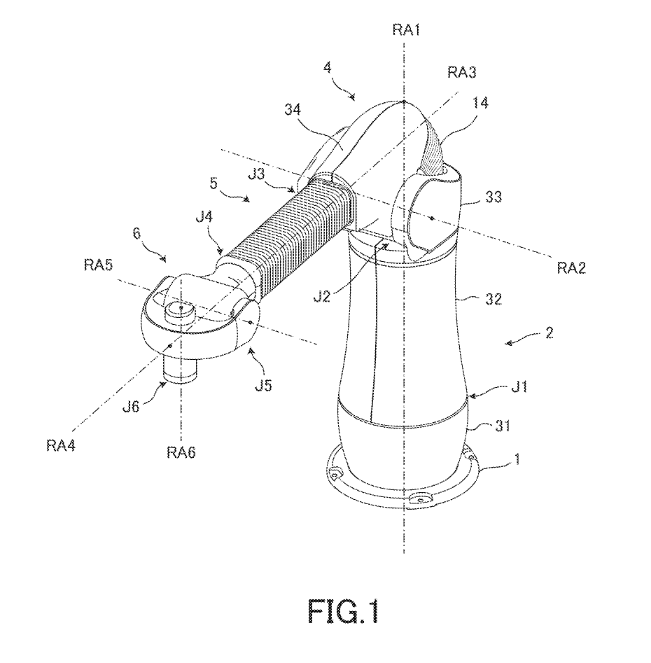

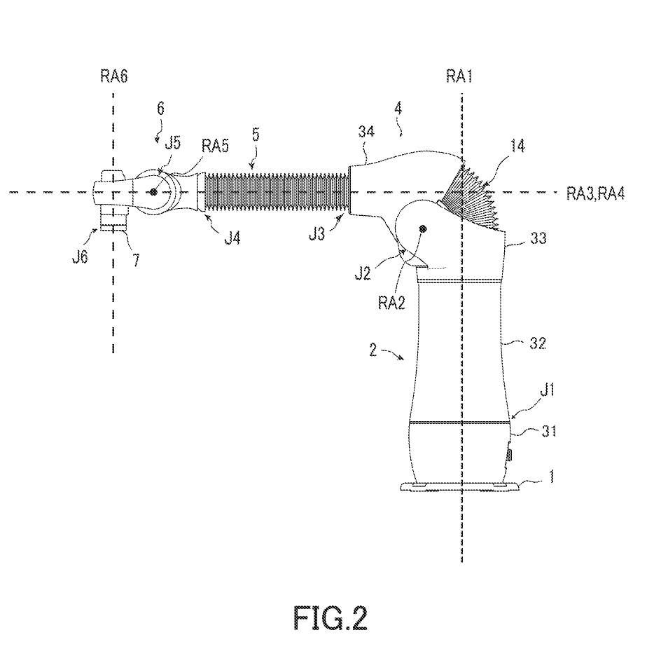

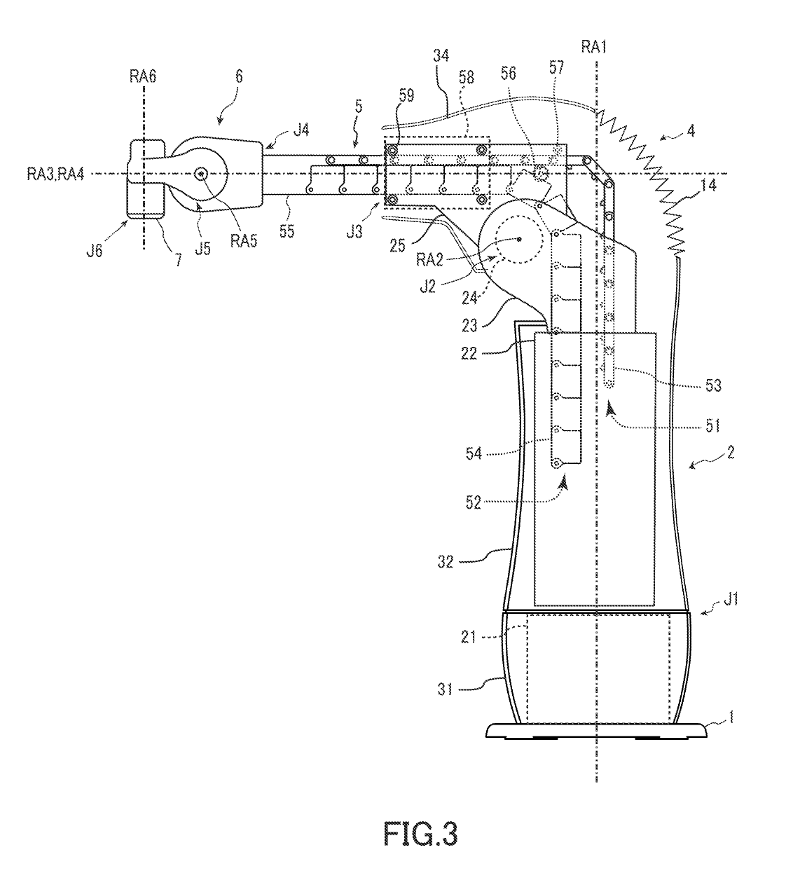

FIG. 1 illustrates an external view of a robot arm mechanism equipped with a torsional rotational joint mechanism according to the present embodiment. FIG. 2 is a side view of the robot arm mechanism in FIG. 1. FIG. 3 is a side view illustrating an internal structure of the robot arm mechanism in FIG. 1.

The robot arm mechanism includes a base 1, a turning section (support section) 2, a rising and lowering section 4, an arm section 5 and a wrist section 6. The turning section 2, the rising and lowering section 4, the arm section 5 and the wrist section 6 are arranged in order from the base 1. A plurality of joints J1, J2, J3, J4, J5 and J6 are arranged in order from the base 1. The rotational joint mechanism according to the present embodiment is realized by a torsion joint of the fourth joint J4. The turning section 2 which forms a cylindrical body is typically installed vertically on the base 1. The turning section 2 houses the first joint J1 as a turning rotational joint. The first joint J1 includes an axis of torsional rotation RA1. The axis of rotation RA1 is parallel to a vertical direction.

The turning section 2 has a lower frame 21 and an upper frame 22. One end of the lower frame 21 is connected to a fixed section of the first joint J1. The other end of the lower frame 21 is connected to the base 1. The lower frame 21 is covered with a housing 31 in a cylinder shape. The upper frame 22 is connected to a rotating section of the first joint J1, and axially rotates on the axis of rotation RA1. The upper frame 22 is covered with a housing 32 in a cylinder shape. The upper frame 22 rotates with respect to the lower frame 21 in accordance with the rotation of the first joint J1, and thereby the arm section 5 turns horizontally. In an internal hollow of the turning section 2 forming the cylindrical body, a first and second piece strings 51 and 52 of the third joint J3 as a linear extension and retraction mechanism that will be described later are housed.

The rising and lowering section 4 that houses the second joint J2 as a rising and lowering rotational joint is installed on an upper part of the turning section 2. The second joint J2 is a bending rotational joint. An axis of rotation RA2 of the second joint J2 is perpendicular to the axis of rotation RA1. The rising and lowering section 4 has a pair of side frames 23 as a fixed section (support body) of the second joint. J2. The pair of side frames 23 are connected to the upper frame 22. The pair of side frames 23 are covered with a cover 33 in a saddle shape. A cylindrical body 24 as a rotating section of the second joint J2, which is also used as a motor housing, is supported by the pair of side frames 23.

A sending-out mechanism 25 is attached to a circumferential surface of the cylindrical body 24. The sending-out mechanism 25 is covered with a cover 34 in a cylinder shape. A gap between the saddle-shaped cover 33 and the cylindrical cover 34 is covered with a U-shaped pleated cover 14 having a U-shaped section.

The U-shaped pleated cover 14 extends and retracts by following rising and lowering motions of the second joint J2.

The sending-out mechanism 25 holds a drive gear 56, a guide roller 57 and a roller unit 58. The sending-out mechanism 25 rotates in accordance with the axial rotation of the cylindrical body 24, and the arm section 5 supported by the sending-out mechanism 25 rises and lowers up and down.

The third joint J3 is provided by the linear extension and retraction mechanism. The linear extension and retraction mechanism includes a structure that is newly developed by the inventors, and is clearly distinguished from a so-called conventional linear motion joint from the viewpoint of a movable range. The arm section 5 of the third joint J3 is bendable, but when the arm section 5 is sent out forward from the sending-out mechanism 25 at a root of the arm section 5 along a center axis (center axis of extension and retraction RA3), bending of the arm section 5 is restricted, and linear rigidity is ensured. When the arm section 5 is pulled backward, bending is restored. The arm section 5 has the first piece string 51 and the second piece string 52. The first piece string 51 is constituted of a plurality of first pieces 53 that are connected to be bendable. The first piece 53 is formed into a substantially flat-plate shape. The first pieces 53 are bendably connected with first hinge sections 300 in spots at end portions. The second piece string 52 is constituted of a plurality of second pieces 54. The second piece 54 is formed into a groove-shaped body with a U-shaped cross section or a tubular body with a hollow-square-shaped cross section. The second pieces 54 are bendably connected with second hinge sections 400 in spots at bottom plate end portions. Bending of the second piece string 52 is restricted in a position where end surfaces of side plates of the second pieces 54 abut on one another. In that position, the second piece string 52 is arranged linearly. Details of the first and second hinge sections 300 and 400 will be described later. The leading first piece 53 of the first piece string 51 and the leading second piece 54 of the second piece string 52 are connected by a head piece 55. For example, the head piece 55 has a shape obtained by combining the first piece 53 and the second piece 54.

The first and second piece strings 51 and 52 are pressed against each other and overlapped with each other by a roller 59 when the first and second piece strings 51 and 52 pass through the roller unit 58 of the sending-out mechanism 25. By being overlapped with each other, the first and second piece strings 51 and 52 exhibit linear rigidity, and constitute the columnar arm section 5. Behind the roller unit 58, the drive gear 56 is disposed with the guide roller 57. The drive gear 56 is connected to a motor unit not illustrated. The motor unit generates power for rotating the drive gear 56. A linear gear is formed along a connection direction, in a center of a width of an inner surface of the first piece 53, that is, a surface at a side where the first piece 53 is overlapped with the second piece 54. Linear gears that are adjacent to one another when the plurality of first pieces 53 are aligned linearly are connected to one another linearly, and constitute a long linear gear. The drive gear 56 is engaged with the linear gear of the first piece 53 which is pressed by the guide roller 57. The linear gears which are connected linearly constitute a rack and pinion mechanism with the drive gear 56. When the drive gear 56 rotates forward, the first and second piece strings 51 and 52 are sent out forward from the roller unit 58. When the drive gear 56 rotates backward, the first and second piece strings 51 and 52 are pulled backward of the roller unit 58. The first and second piece strings 51 and 52 which are pulled back are separated from each other between the roller unit 58 and the drive gear 56. The first and second piece strings 51 and 52 which are separated respectively return to bendable states. The first and second piece strings 51 and 52 which return to bendable states both bend in a same direction (inward), and are vertically housed in the turning section 2. At this time, the first piece string 51 is housed in a state in which the first piece string 51 is substantially aligned substantially parallel to the second piece string 52.

The wrist section 6 is attached to a tip of the arm section 5. The wrist section 6 is equipped with fourth to sixth joints J4 to J6. The fourth to sixth joints J4 to J6 respectively include axes of rotation RA4 to RA6 which are orthogonal three axes. The fourth joint J4 is a torsional rotational joint that rotates on the fourth axis of rotation RA4 which substantially matches the center axis of extension and retraction RA3, and by rotation of the fourth joint J4, an end effector is swingably rotated. The fifth joint J5 is a bending rotational joint that rotates on the fifth axis of rotation RA5 disposed perpendicularly to the fourth axis of rotation RA4, and by rotation of the fifth joint J5, the end effector is pivoted forward and backward. The sixth joint. J6 is a torsional rotational joint that rotates on the sixth axis of rotation RA6 disposed perpendicularly to the fourth axis of rotation RA4 and the fifth axis of rotation RA5, and the end effector is axially rotated by rotation of the sixth joint J6.

The end effector is attached to an adapter 7 provided at a lower part of a rotating section of the sixth joint J6 of the wrist section 6. The end effector is a section having a function of directly acting on an object to be worked (a work) by a robot, and various tools exist in accordance with tasks, such as a holding section, a vacuum suction section, a nut fastening tool, a welding gun, and a spray gun, for example. The end effector is moved to a given position by the first, second and third joints J1, J2 and J3, and is placed in a given posture by the fourth, fifth and sixth joints J4. J5 and J6. In particular, a length of an extension and retraction distance of the arm section 5 of the third joint J3 enables the end effector to reach an object in a wide range from a position close to the base 1 to a position far from the base 1. In the third joint J3, the linear extension and retraction motions and the length of the extension and retraction distance realized by the linear extension and retraction mechanism constituting the third joint J3 are characteristics that differ from the conventional linear motion joint.

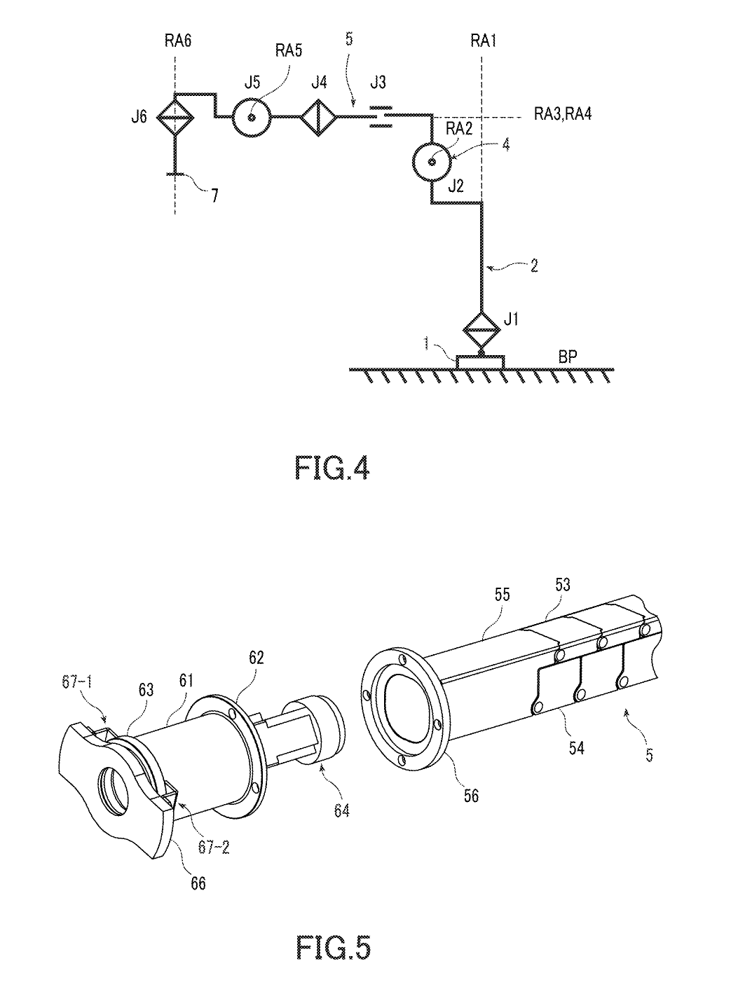

FIG. 4 shows the structure of the robot arm mechanism by graphic symbol expression. In the robot arm mechanism, three degrees of freedom of position are realized by the first joint 41, the second joint J2 and the third joint J3 that constitute root three axes. Further, three degrees of freedom of posture are realized by the fourth joint J4, the fifth joint J5 and the sixth joint J6 that constitute wrist three axes. As illustrated in FIG. 4, the axis of rotation RA1 of the first joint J1 is provided in a vertical direction. The axis of rotation RA2 of the second joint J2 is provided in a horizontal direction. The second joint J2 is offset with respect to two directions that are the axis of rotation RA1 and an axis orthogonal to the axis of rotation RA1 with respect to the first joint J1. The axis of rotation RA2 of the second joint J2 does not intersect the axis of rotation RA1 of the first joint J1. The axis of movement RA3 of the third joint J3 is provided in a perpendicular direction with respect to the axis of rotation RA2. The third joint. J2 is offset with respect to two directions that are the axis of rotation RA1 and an axis orthogonal to the axis of rotation RA1 with respect to the second joint J2. The axis of rotation RA3 of the third joint J3 does not intersect the axis of rotation RA2 of the second joint J2. One bending joint of the root three axes of the plurality of joints J1 to J6 is replaced with the linear extension and retraction joint J3, the second joint J2 is offset to the two directions with respect to the first joint J1, and the third joint J3 is offset to the two directions with respect to the second joint J2, whereby the robot arm mechanism of the robot apparatus according to the present embodiment structurally eliminates a singularity posture.

FIG. 5 is a perspective view showing a structure of a joining section of the wrist section 6 and the arm section 5 in FIG. 3. A fixed section 61 of the fourth joint J4 as a torsional rotational joint is connected to the leading block 55 of the arm section 5. The fixed section 61 is typically cylindrical, but may be in a tube shape with a rectangular cross section, or a tube shape with a polygonal cross section having five sides or more, or may be in an oblong cylinder shape or an elliptic cylinder shape. In this case, the fixed section 61 is described as cylindrical, and will be referred to as a cylindrical frame hereinafter.

The leading block 55 is typically a square tubular body that closely resembles an outer shape obtained by overlapping the first and second pieces 53 and 54. At a tip of the leading block 55, an annular flange 56 is jutted to outside. The fixed section of the fourth joint J4 is a cylindrical frame 61 in a cylindrical shape. At front and rear ends of the cylindrical frame 61, annular flanges (flange sections) 62 and 63 are respectively jutted to outside. The flange 62 at the rear end of the cylindrical frame 61 is connected to the flange 56 of the leading block 55 by bolts and nuts, and thereby the cylindrical frame 61 (the fixed section of the fourth joint J4) is fixed to the tip of the arm section 5. An internal hollow of the cylindrical frame 61 fixed to the tip of the arm section 5 is continuous to an internal hollow of the leading block 55. In the hollow parts continuous to each other, a motor unit 64 constituted of a motor generating power for driving the fourth joint J4 and a gearbox is housed. The motor unit 64 is fitted into the cylindrical frame 61 and is fixed. A structure in which the motor unit 64 of the fourth joint J4 is housed in the internal hollows from the arm section 5 through the cylindrical frame 61 (the fixed section of the fourth joint J4) in this way contributes to reduction in size and weight of the fourth joint J4, as compared with the structure in which the motor unit 64 is fixed to an outer circumferential surface of the cylindrical frame 61, and a structure in which the motor unit 64 is fixed to a rotating section side. This reduces a load due to moment that is exerted on the roller unit 58 that supports the arm section 5. An output shaft 65 of the motor unit 64 is directly connected to a strip-shaped frame 61, for example, as a rotating section of the fourth joint J4. Directly connecting the output shaft 65 of the motor unit 64 to the rotation plate (rotating section) 66 can eliminate the need for a rotational joint structure between the cylindrical frame (fixed section) 61 and the rotation plate (rotating section) 66, and can simplify the structure of the fourth joint J4.

(Falling-Off Prevention Mechanism)

The wrist section 6 is held with respect to the arm section 5 by the output shaft 65 of the motor unit 64 that is directly connected to the rotating section of the fourth joint J4. This generates a risk of the wrist section 6 falling off from the arm section 5 by the output shaft. 65 only breaking for the reason of aged deterioration or the like, while simplifying the structure of the fourth joint J4 as described above. The fourth joint J4 as the rotational joint mechanism according to the present embodiment includes a falling-off prevention mechanism that prevents falling-off of the rotating section with respect to the fixed section.

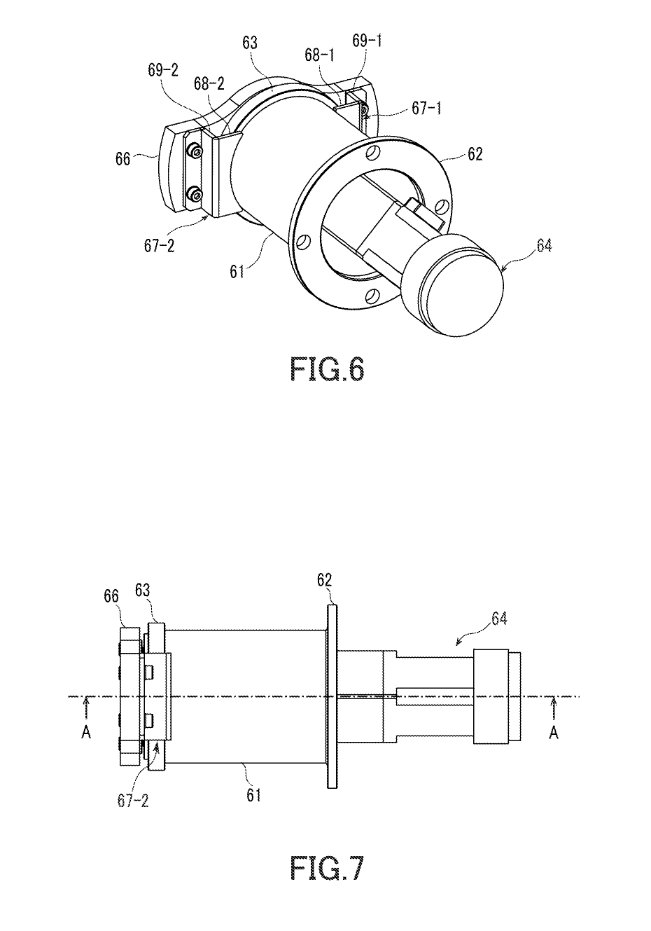

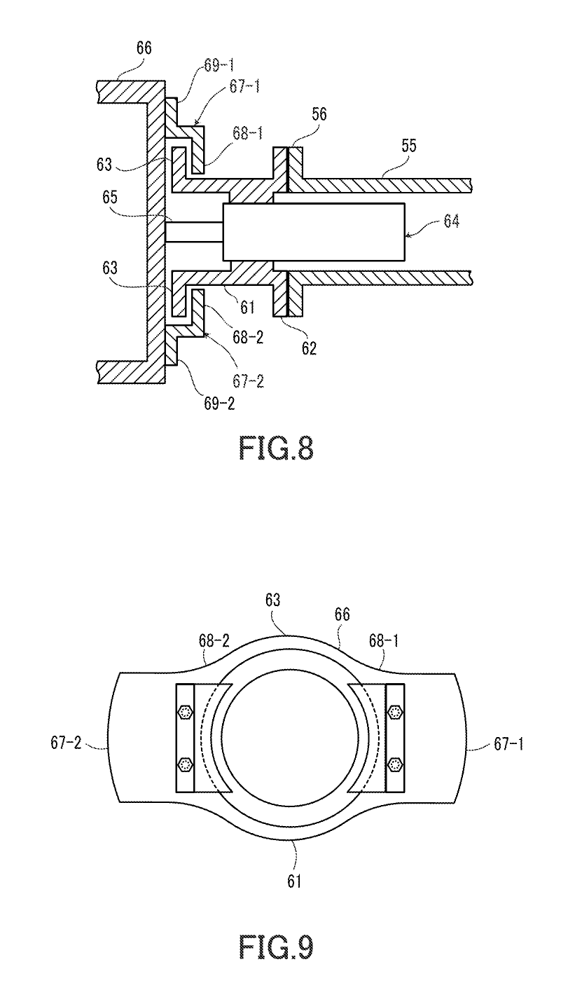

FIG. 6 is a perspective view showing the structure of the torsional rotational joint mechanism J4 according to the present embodiment. FIG. 7 is a side view of the torsional rotational joint mechanism J4 in FIG. 6. FIG. 8 is a sectional view taken along line A-A in the torsional rotational joint mechanism J4 in FIG. 7. FIG. 9 is a plan view showing falling-off prevention plates 68-1 and 68-2 of the torsional rotational joint mechanism J4 in FIG. 6.

The falling-off prevention mechanism includes a pair of falling-off prevention sections 67-1 and 67-2. The pair of falling-off prevention sections 67-1 and 67-2 are attached to a rear end surface (the rotating section side of the fourth joint J4) of the rotation plate 66. The falling-off prevention sections 67-1 and 67-2 are constituted of the falling-off prevention plates 68-1 and 68-2, and L-shaped support plates 69-1 and 69-2 that are fixed to the rotation plate 66. In reality, the falling-off prevention sections 67-1 and 67-2 are each formed by a metal plate being bent at right angles in opposite directions at two spots. Edge sections of tips of the falling-off prevention plates 68-1 and 68-2 are each formed into an arc-shaped concave shape forming a part of a concentric circle with an outer circumferential surface of the cylindrical frame 61. A central angle of the are is typically an angle selected from a range of 60 degrees to 120 degrees. The falling-off prevention plates 68-1 and 68-2 each have a width corresponding to a central angle of an are of an edge section at the tip. Rear ends of the falling-off prevention plates 68-1 and 68-2 are connected to tips of the support plates 69-1 and 69-2. Widths of the support plates 69-1 and 69-2 are substantially equivalent to widths of the rear end portions of the falling-off prevention plates 68-1 and 68-2. Heights of the support plates 69-1 and 69-2 are larger than a distance from the rear end surface of the rotation plate 66 to a rear end surface of the flange 63 of the cylindrical frame 61. Rear end portions of the support plates 69-1 and 69-2 are fastened to the rotation plate 66 by fastening tools such as screws, whereby the pair of falling-off prevention sections 67-1 and 67-2 are attached to the rotation plate 66.

The pair of falling-off prevention sections 67-1 and 67-2 are attached to the rear end surface of the rotation plate 66 in such a manner that the falling-off prevention plates 68-1 and 68-2 and the rotation plate 66 sandwich the flange 63 at the tip of the cylindrical frame 61. The falling-off prevention plates 68-1 and 68-2 are installed parallel to a cross section of the cylindrical frame 61, and in a symmetrical positional relation to a center axis of the cylindrical frame 61 with the cylindrical frame 61 between the falling-off prevention plates 68-1 and 68-2. The edge sections in the arc shape of the falling-off prevention plates 68-1 and 68-2 face the outer circumferential surface of the cylindrical frame 61. A slight gap is left between the tip edge sections of the falling-off prevention plates 68-1 and 68-2, and the outer circumferential surface of the cylindrical frame 61.

According to the falling-off prevention mechanism described above, even when the output shaft 65 is broken for some reason, movement of the rotation plate 66 about an axial direction of the cylindrical frame 61 is restrained by the falling-off prevention plates 68-1 and 68-2 which are attached to the rotation plate 66 abutting on the flange 63 at the tip of the cylindrical frame 61. The tip edge sections each in the arc shape of the falling-off prevention plates 68-1 and 68-2 which are attached to the rotation plate 66 cover the outer circumference of the cylindrical frame 61 within any angle range of a range of 120 degrees to 240 degrees, preferably at more than 180 degrees, whereby movement of the rotation plate 66 about a radial direction of the cylindrical frame 61 is also restrained. Accordingly, falling-off of the rotation plate (rotating section) 66 from the cylindrical frame (fixed section) 61 is avoided by the falling-off prevention sections 67-1 and 67-2. Falling-off of the wrist section 6 from the arm section 5 is avoided.

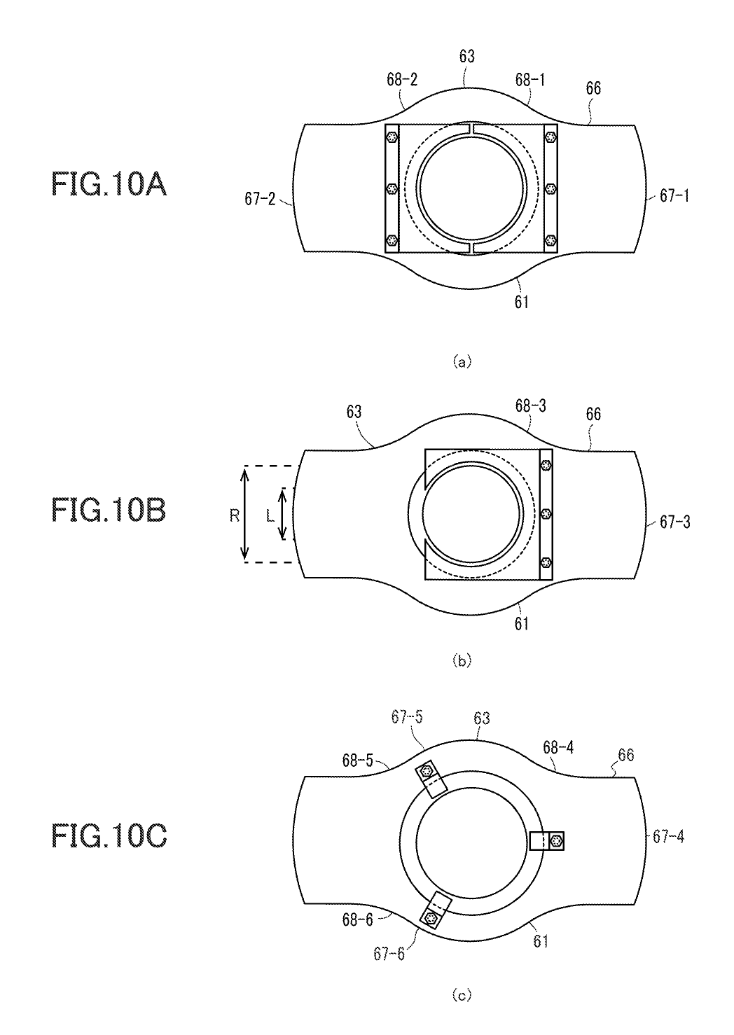

Note that the falling-off prevention mechanism is not limited to this. FIGS. 10A to 10C are views showing other examples of the falling-off prevention plates 68-1 and 68-2 in FIG. 9. Here, the central angle of the arc of the edge section of the tip of the falling-off prevention plates 68-1 and 68-2 are each typically an angle selected from the range from 60 degrees to 120 degrees, but it is not denied that the central angle of the arc has more than 120 degrees. If only the central angle of the are is within the range of 120 degrees to an angle less than 180 degrees, the central angles of the arcs of the edge sections of the tips of the falling-off prevention plates 68-1 and 68-2 may be slightly less than 180 degrees, as shown in FIG. 10A, for example.

Further, the falling-off prevention mechanism is described as including the pair of falling-off prevention sections 67-1 and 67-2, but may include a single falling-off prevention section or three or more falling-off prevention sections. As shown in FIG. 10B, the falling-off prevention mechanism may include a single falling-off prevention section 67-3. A central angle of an are of an edge section of a tip of a falling-off prevention plate 68-3 is an angle selected from a range of more than 180 degrees but less than 360 degrees, and is preferably an angle necessary for a linear distance L from one end to the other end of the are to be shorter than a diameter R of the cylindrical frame 61. As shown in FIG. 10C, the falling-off prevention mechanism may include three falling-off prevention sections 67-4, 67-5 and 67-6. The falling-off prevention sections 67-4, 67-5 and 67-6 are provided to be equally spaced on a concentric circle of the cylindrical frame 61. In falling-off prevention plates 68-4, 68-5 and 68-6, edge sections at tips thereof do not have to be in arc shapes, and widths thereof may be small.

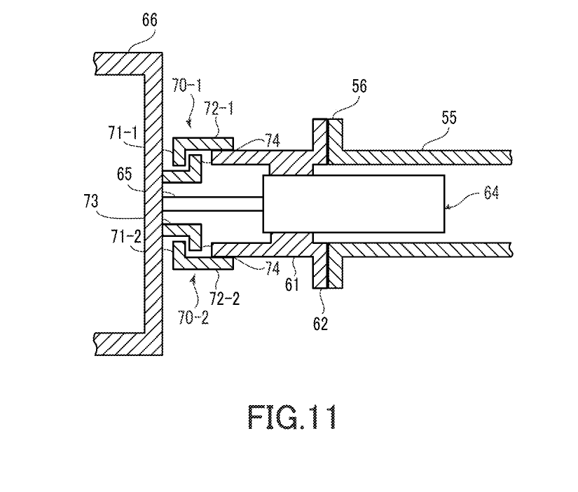

Further, in the above, the pair of falling-off prevention sections 67-1 and 67-2 are described as being mounted to the rotating section (rotation plate) 66, and the annular body (flange) 63 is described as being mounted to the fixed section (cylindrical frame) 61, but as shown in FIG. 11, a pair of falling-off prevention sections 70-1 and 70-2 may be mounted to the fixed section (cylindrical frame) 61, and an annular body (flange) 74 may be mounted to the rotating section (rotation plate) 66. The annular body 74 is fixed by being slightly separated from the rear end surface of the rotation plate 66 via a base 73 in a cylindrical shape. Falling-off prevention plates 71-1 and 71-2 are fixed separately from the tip of the cylindrical frame 61 via support plates 72-1 and 72-2 so as to project forward from the tip of the cylindrical frame 61. Edge sections at tips of the falling-off prevention plates 71-1 and 71-2 are each formed into an arc-shaped concave shape forming a part of a concentric circle with an outer circumferential surface of the cylindrical base 73. A central angle of the arc is typically an angle selected from a range of 60 degrees to 120 degrees. The falling-off prevention plates 71-1 and 71-2 each have a width corresponding to the central angle of the arc of the edge section at the tip thereof.

The pair of falling-off prevention sections 70-1 and 70-2 are attached to the tip of the cylindrical frame 61 in such a manner that the falling-off prevention plates 71-1 and 71-2 are sandwiched between the rotation plate 66 and the annular body 74.

With the structure like this, falling-off of the rotation plate (rotating section) 66 from the cylindrical frame (fixed section) 61 can be avoided by the falling-off prevention sections 70-1 and 70-2 even if the output shaft 65 is broken for some reason, and thereby falling-off of the wrist section 6 from the arm section 5 can be avoided.

Further, the falling-off prevention structure is not applied limitedly to the torsional rotational joint mechanism, but also can be applied to a so-called cantilever rotation mechanism that supports a rotating section in a cantilever manner rotatably with respect to the fixed section. That is, an annular body is provided at one of the fixed section and the rotating section, and one or two or more falling-off prevention sections are attached to an end surface of the other one of the fixed section and the rotating section in such a manner that the annular body is sandwiched between the one or two or more falling-off prevention sections and the end surface of the other one of the fixed section and the rotating section.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### REFERENCE SIGNS LIST

5 . . . Arm section, 53 . . . First piece, 54 . . . Second piece, 55 . . . Leading block. 6 . . . Wrist section. 61 . . . Cylindrical frame (fixed section of fourth joint J4), 56, 62, 63 . . . Flange (Flange section), 64 . . . Motor unit. 65 . . . Output shaft, 66 . . . Rotation plate (rotating section of fourth joint J4), 67-1, 67-2 . . . Falling-off prevention section, 68-1, 68-2 . . . Falling-off prevention plate, 69-1, 69-2 . . . Support frame

1. A torsional rotational joint mechanism that is mounted to a robot arm mechanism comprising:
a cylindrical fixed section;
a motor unit that is housed in the fixed section; and
a rotating section that is fixed to an output shaft of the motor unit,
wherein a flange section in an annular shape is jutted out at one of the fixed section and the rotating section to project outward, and one or two or more falling-off prevention sections is or are attached to an end surface of the other one of the fixed section and the rotating section in such a manner that the flange section is sandwiched between the one or two or more falling-off prevention sections and the end surface of the other one of the fixed section and the rotating section.

2. The torsional rotational joint mechanism according to claim 1,
wherein the falling-off prevention section faces an outer circumferential surface of one of the fixed section and the rotating section in an edge section, and the edge section is formed into an arc-shaped concave shape forming a part of a concentric circle with the outer circumferential surface of the one of the fixed section and the rotating section.

3. The torsional rotational joint mechanism according to claim 2,
wherein each of the two falling-off prevention sections has a width corresponding to any angle within a range of 60 degrees to 120 degrees of the concentric circle.

4. The torsional rotational joint mechanism according to claim 2,
wherein an end surface of each of the two falling-off prevention sections has a width corresponding to an angle of 180 degrees of the concentric circle.

5. The torsional rotational joint mechanism according to claim 2,
wherein the three falling-off prevention sections are provided to be equally spaced on the concentric circle.

6. The torsional rotational joint mechanism according to claim 2,
wherein an end surface of the one falling-off prevention section has a width corresponding to any angle within a range of more than 180 degrees but less than 360 degrees of the concentric circle.

7. A robot arm mechanism in which a support section including a turning rotational joint is supported on a base, a rising and lowering section including a rising and lowering rotational joint is placed on the support section, a linear extension and retraction mechanism including an arm section with linear extension and retraction properties is provided at the rising and lowering section, a wrist section to which an end effector can be fitted is mounted to a tip of the arm section, and a torsional rotational joint for changing a posture of the end effector is mounted to the wrist section,
wherein the torsional rotational joint comprises
a cylindrical fixed section,
a motor unit that is housed in the fixed section, and
a rotating section that is fixed to an output shaft of the motor unit,
a flange section in an annular shape is jutted out at one of the fixed section and the rotating section to project outward, and one or two or more falling-off prevention sections is or are attached to an end surface of the other one of the fixed section and the rotating section in such a manner that the flange section is sandwiched between the one or two or more falling-off prevention sections and the end surface of the other one of the fixed section and the rotating section.

8. A cantilevered rotation mechanism comprising:
a fixed section;
a rotating section that is supported in a cantilever manner rotatably with respect to the fixed section;
an annular body that is provided at one of the fixed section and the rotating section; and
one or two or more falling-off prevention sections that is or are attached to an end surface of the other one of the fixed section and the rotating section in such a manner that the annular body is sandwiched between the one or two or more falling-off prevention sections and the end surface of the other one of the fixed section and the rotating section.
